(19) United States
(12) Patent Application Publication
(10) Pub. No.: US 2015/0081331 A1
(43) Pub. Date: Mar. 19, 2015

(54) SOFTWARE FOR STREAMLINED ACCESS BETWEEN AN EMERGENCY ROOM AND WEB-BASED MEDICAL SOFTWARE

(71) Applicant: Quality Health Ideas LLC, Wilbraham, MA (US)

(72) Inventor: Philip F. Gaziano, Wilbraham, MA (US)

(21) Appl. No.: 14/308,028

(22) Filed: Jun. 18, 2014

Related U.S. Application Data
(60) Provisional application No. 61/879,870, filed on Sep. 19, 2013.

(51) Int. Cl. G06F 19/00

(52) U.S. Cl. CPC G06F 19/322
USPC 705/3

(57) ABSTRACT

Applicant has disclosed a software tool which allows quick access by medical providers (e.g., in a hospital emergency room) to patient records stored on web-based medical software. In a preferred embodiment, the software tool allows integration with a third-party Electronic Medical Record (“EMR”) software, e.g., used by a medical provider, by capturing screen data from the third-party software, querying a database of the web-based medical software as to whether or not the database contains an active medical record number associated with the patient, and notifying the medical provider of the patient's medical record number status within the web-based medical software. If that record number is active, the provider can click upon a link and be passed directly to an electronic medical record for the specific patient in the web-based medical software.

### RELATED APPLICATION

This application claims priority to U.S. Provisional Patent Application, Ser. No. 61/879,870, entitled “SOFTWARE FOR STREAMLINED ACCESS BETWEEN AN END USER′S EMR SYSTEM AND WEB-BASED MEDICAL SOFTWARE,” filed Sep. 19, 2013. Applicant claims priority from that application. Applicant also hereby incorporates by reference that application in its entirety.

### FIELD OF INVENTION

This invention relates to medical software. More specifically, it relates to software to assist medical providers during patient encounters.

### BACKGROUND OF THE INVENTION

U.S. Pat. No. 8,321,244 to Gaziano (“Gaziano”), entitled “Software System for Aiding Medical Practitioners and Their Patients,” issued Nov. 27, 2012. Gaziano discloses a software system, preferably run over the Internet, to prompt medical providers to check certain medical conditions based upon: a patient's history from, for example, prior office visits; and preferably, if appropriate, the patient's history from other sources. Using the system results in more thorough care and enhanced billing. Gaziano's software provides, among other things, a digital (or printed) version of a familiar billing format—the so-called Superbill. Medical conditions of a patient are highlighted to ensure the medical service provider performed the following services during a patient visit or “encounter”: investigating medical conditions of the patient, as prompted by highlights in the Superbill; and exhaustively addressing all the conditions worthy of investigation based on stored patient information. Afterwards, additional data obtained from the visit are entered into the computer system for later use.

The software product disclosed in Gaziano is currently available as a web-based, on-demand service identified by the trademark “CareScreen”. Accountable Care

Associates, Inc. of Springfield, MA offers this on-demand service. CareScreen™ software currently provides for web-based data sharing, reporting, management, insurance coding (for billing) and compliance tools.

Digitally stored patient information, such as that storable on CareScreen, is sometimes crucial to emergency room doctors. Patient history can enable an emergency room doctor, for example, to provide immediately life-saving treatment where precious seconds count. If that history is not readily available, consequences can ensue.

Accordingly, it is a primary object of the present invention to allow streamlined access between an end user's Electronic Medical Record (“EMR”) system and CareScreen.

It is another object to increase the functional usage of CareScreen™ software by allowing users (e.g., emergency room medical providers) to quickly move from their third-party to a CareScreen patient without needing to log into CareScreen and search for the patient.

### SUMMARY

Applicant has disclosed a software tool to increase the functional usage of CareScreen™ software (see U.S. Pat. No. 8,321,244). This tool, marketed under the trademark “CareScreen Connect,” allows users to quickly move from their third-party Electronic Medical Record (“EMR”) to a CareScreen patient without needing to log into CareScreen and search for the patient. By removing these two steps, end user speed is increased and the possibility for end user error is decreased.

In the preferred embodiment, the CareScreen Connect™ product allows integration with third-party EMR software by capturing screen data from the third-party EMR software, querying the CareScreen database server for membership (if CareScreen is logged on within the user's company) of a patient, and notifying the end user of the patient's status within CareScreen. Once the user has been notified that their patient is CareScreen eligible, the user can click upon a provided link to be taken directly to that patient's record within CareScreen.

### BRIEF DESCRIPTION OF THE DRAWINGS

The above objects and other advantages of the invention will become more readily apparent upon reading the following description and drawings, in which:

FIG. 1 is a flow chart of CareScreen Connect™ data capture, verification and CareScreen access;

FIG. 2 is a flow chart of the CareScreen Connect™ processing loop for patient data capture and verification;

FIG. 3 depicts a CareScreen Connect™ eligibility pop-up; and

FIG. 4 depicts a CareScreen Connect™ setup page.

### DETAILED DESCRIPTION OF THE PREFERRED EMBODIMENT

Applicant's present invention relates to U.S. Pat. No. 8,321,244 to Gaziano, entitled “Software System for Aiding Medical Practitioners and Their Patients,” issued Nov. 27, 2012. The patented software product (known as CareScreen™) of U.S. Pat. No. 8,321,244 is currently available as a web-based, on-demand service. Accountable Care Associates, Inc., headquartered in Springfield, MA, offers this on-demand service. CareScreen™ software currently provides for web-based data sharing, reporting, management, insurance coding (for billing) and compliance tools.

Applicant is also the patentee of U.S. Pat. No. 8,321,244. Applicant hereby incorporates that patent herein by reference in its entirety.

As used in the present application, the terms “medical providers” includes doctors and nurse practitioners at any location known for providing medical services, such as a doctor's office, a doctors' group, or a hospital or an outpatient clinic.

The present invention (marketed as CareScreen Connect™) captures data from the end user's EMR, validates against the CareScreen database, and notifies the end user if the patient is eligible within the CareScreen application. CareScreen Connect™ will then allow the user to be taken directly to the patient record within CareScreen, bypassing the logon and patient search screens. This will provide increased usage of the CareScreen application and decreased system usage time, leading to better patient chronic condition care and allowing providers to spend more time with their patients.

The CareScreen Connect™ software is a standalone product that can be installed on each computer at a participating CareScreen client which will also be utilizing their third-party EMR system. Each CareScreen client installation will be configured to allow access to their data only, and the CareScreen data server will allow access by IP subnet range. This will prevent end users from seeing any data except their own.

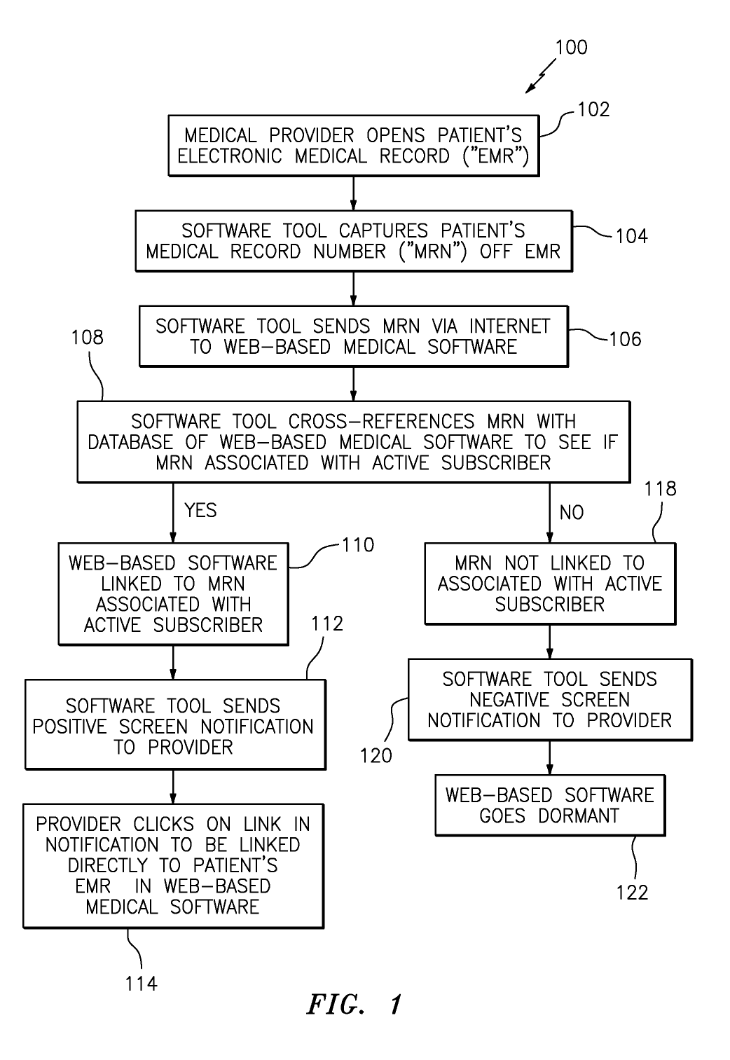

CareScreen Connect™ runs in the background of the user's computer. As best disclosed in accompanying FIG. 1, CareScreen Connect™ watches for activity within the Electronic Medical Record (“EMR”)(currently this works with AllScripts EMR). When CareScreen Connect™ detects certain screens/patient data, it provides the ability to launch CareScreen directly from the EMR, navigating directly to the corresponding patient from the EMR.

The preferred method embodiment 100, shown in FIG. 1, comprises: a medical provider opens a patient's EMR within the provider's (or hospital's) system (step 102); a local client installation of CareScreen Connect™ software captures the patient's Medical Record Number (“MRN”) from the EMR (step 104); the MRN and additional site information (e.g., patient name and birthday) is sent over a secure Internet connection to a server for the CareScreen™ software (step 106); CareScreen then tries to verify that the patient has a CareScreen record associated with an active CareScreen subscriber (step 108) by cross-referencing the MRN (and preferably some additional site information) with a CareScreen database. A medical group or hospital would be the subscriber, not the patient.

If the patient is verified (in step 108), CareScreen links the MRN to a CareScreen EMR record for the patient (step 110) and the following steps occur: the CareScreen Connect™ web service sends a positive result with a corresponding Subscriber ID to the local CareScreen Connect™ program (step 112); CareScreen Connect™ displays (step 114) that a CareScreen patient match has been found, either by modifying the EMR screen or by displaying an eligibility pop-up 116 (see FIG. 3); and, the medical provider clicks on CareScreen Connect™ (e.g., via a “Open Patient in CareScreen” button 118 with a hyperlink in FIG. 3) and is taken to the digital patient record within CareScreen without requiring a user login.

Applicant does not intend the CareScreen eligibility or non-eligibility pop-up screens 116 to be a full-screen display. That way, the pop-up (which appears) does not interfere with using another screen display from different software.

If the patient is not verified, CareScreen fails to link to an active CareScreen patient (step 118) and the CareScreen Connect™ web service sends a negative result to the local CareScreen Connect™ program (step 120) by displaying a non-eligibility pop-up screen (not shown). Since the CareScreen patient was not found, the CareScreen Connect™ patient file goes dormant and waits for the next MRN (step 122).

The CareScreen Connect™ process is facilitated by intercepting data from the EMR application (step 104) from its Internet browser based user interface, and then using a process called Historically Hypertext Markup Language (“HTML”) injection to place the graphic “Open Patient in CareScreen” button 118 (see FIG. 3) with a hyperlink to CareScreen into a patient header bar of the EMR user interface.

The CareScreen Connect™ program accomplishes this by accessing the MSHTML interface of Internet Explorer through the COM interface. MSHTML (Mshtml.dll) is at the heart of Internet Explorer and takes care of its

HTML and Cascading Style Sheets (“CSS”) parsing and rendering functionality. MSHTML is sometimes referred to by its code name, “Trident”. MSHTML exposes interfaces that enable you to host it as an active document. In other words, MSHTML is the main rendering engine of Internet Explorer and it exposes the Document Object Model of the web page(s) currently being viewed in Internet Explorer.

MSHTML is the name of the layout engine for the Microsoft® Windows® version of Internet Explorer. A web browser engine (sometimes called layout engine or rendering engine) is a software component that takes marked up content (such as HTML, XML, image files) and formatting information (such as CSS, XSL) and displays the formatted content on the screen. It draws on the content area of a window, which is displayed on a monitor or a printer.

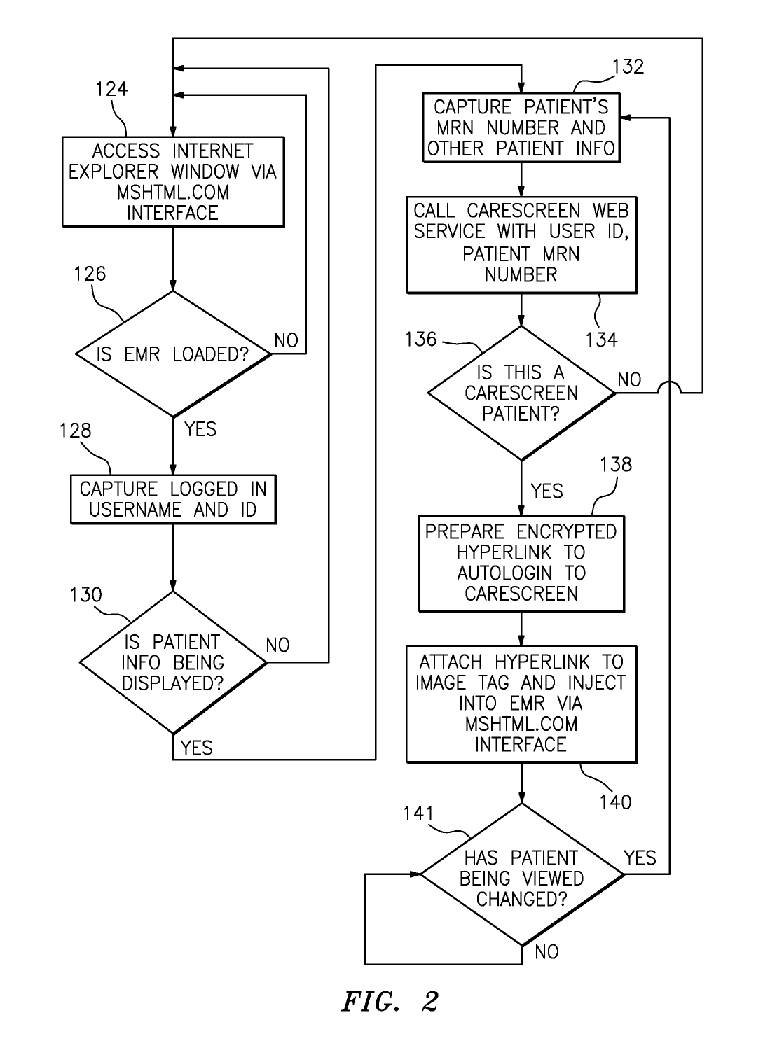

FIG. 2 is a flow chart of the CareScreen Connect™ processing loop for patient data capture and verification. Some of the steps are similar to those disclosed in the upper-level flow chart in FIG. 1.

As shown in FIG. 2, CareScreen Connect™ automatically accesses Internet Explorer via an MSHTML.com interface (step 124), if the patient's EMR is loaded on the medical provider's third-party application (step 126). CareScreen Connect™ captures the medical provider's (user's) name and ID (step 128). CareScreen Connect™ then checks (step 130) to see if patient information is being displayed on the screen from that third-party application. If so, CareScreen Connect™ captures (at 132) from the EMR display: the patient's MRN number; and some additional patient information (e.g., name and birthday). CareScreen Connect™ next sends to the web-based CareScreen server the username, user ID, the MRN and the captured patient information (step 134). The CareScreen web-based software then cross-references the patient information (with the CareScreen database) to determine two things: whether that patient has a CareScreen record (step 136); and, if so, whether that record is associated with an active subscriber to CareScreen (step 108—see FIG. 1). If CareScreen Connect™ verifies the patient has a CareScreen record associated with an active subscriber, CareScreen prepares an encrypted hyperlink to auto login to CareScreen (step 138); and CareScreen Connect attaches the hyperlink to an image tag and injects the image tag into the EMR of the medical providers screen display for the third-party software (step 140).

FIG. 2 includes an additional step (141) by which CareScreen Connect™ periodically checks to see if a different patient is being displayed. If CareScreen Connect™ detects another patient, then the process begins anew for the second detected patient.

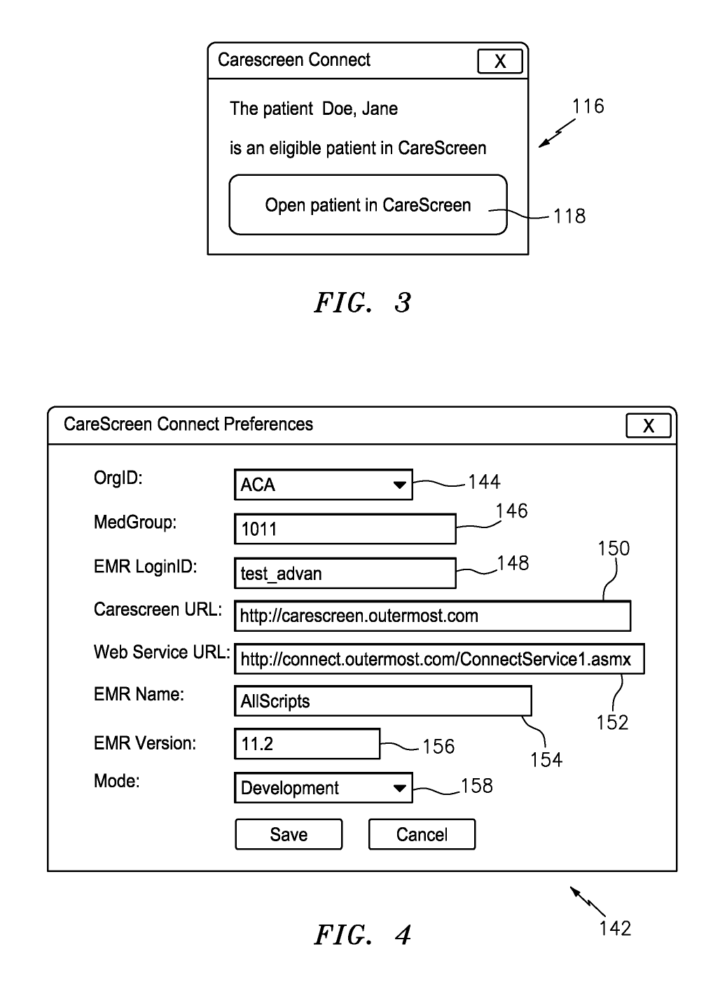

FIG. 4 shows a sample CareScreen Connect™ setup 142 which requires preferences to be listed. Set up 142 requires an ID at 144 (here, ACA which stands for Accountable Care Associates); the Medical Group's CareScreen number at 146; the emergency room login ID at 148; the CareScreen URL at 150; the web service URL for CareScreen at 152; the emergency room name at 154; the particular CareScreen Connect™ version being used by that emergency room at 156; and the mode of CareScreen Connect™ use at 158.

CareScreen Connect™ can also be set up employing a simple “Screen Scraping” technique to obtain patient identifying data from most Windows® applications and use it to open CareScreen and navigate directly to the patient information. Screen scraping, as can be inferred, is the action of using a computer program to copy data from a website.

Screen Scraping in CareScreen Connect™ uses the same MSHTML interface as HTML Injection (see above) to access data in the EMR. MSHTML exposes the Document Object Model (DOM) of the web page being viewed, and CareScreen Connect™ scans the DOM to retrieve a) the logged in username b) the MRN (Medical Record Number) of the patient currently being viewed.

Alternatively, CareScreen Connect™ could be used in a medical group rather than a hospital. In that instance, Applicant's method comprises:
a. automatically capturing screen data about a medical patient from a third-party software running on a medical provider's computer;
   i. wherein the medical provider is part of a medical group;
b. automatically querying a web-based database of medical software with the screen data to verify, provided the medical software is already logged on within a server of the medical group, whether or not a specific patient has an electronic medical record stored in the database; and
c. upon verifying the patient has an electronic medical record stored in the database, automatically providing a screen notification on the medical provider's computer and allowing the medical provider to be passed (e.g., via a provided link in the notification) directly to the patient's electronic medical record without the medical provider having to log onto the web-based medical software and then search for the patient's electronic medical record in the database.

It should be understood by those skilled in the art that obvious structural modifications can be made without departing from the spirit of the invention. Accordingly, reference should be made primarily to the appended claims rather than the foregoing description to determine the scope of the invention.

I claim:

1. A method comprising:
a. automatically capturing screen data about an emergency room patient from a third-party electronic medical record, for the patient, running on a medical provider's computer in an emergency room of a hospital;
b. automatically querying a database of web-based medical software with the screen data to verify, provided the medical software is already logged on in a computer server of the hospital, whether or not the patient has an electronic medical record stored in the database; and
c. upon verifying the patient has an electronic medical record stored in the database:
i. automatically providing a screen notification on the medical provider's computer linking to the patient's electronic medical record; and
ii. thereafter clicking on a link to pass the medical provider directly to the patient's electronic medical record.

2. The method of claim 1 wherein the querying of step (b) in claim 1 comprises cross-referencing an electronic medical record number and a name of the patient, both listed in the screen data, with the database of the web-based medical software.

3. The method of claim 1 wherein the querying of step (b) in claim 1 comprises:
a. automatically sending a medical record number and name of the patient, listed in the screen data, over a secure Internet connection to a server for the medical software;
b. automatically cross-referencing the medical record number and the name with patient information on the medical software; and
c. automatically determining whether or not the medical record number is associated with an active subscriber of the medical software.

4. The method of claim 1 wherein:
a. upon verifying that the patient does not have an electronic medical record stored in the database:
i. automatically sending a negative result to the medical provider's computer; and
ii. thereafter allowing the medical software to go dormant.

5. A method comprising:
a. automatically capturing screen data about a medical patient from a third-party software running on a medical provider's computer in a hospital emergency room;
b. automatically querying a web-based database of medical software with the screen data to verify, provided the medical software is already logged on within a computer server of the hospital, whether or not an emergency room patient has an electronic medical record stored in the database; and
c. upon verifying that the patient has an electronic medical record stored in the database, automatically providing a screen notification on the medical provider's computer and allowing the medical provider to be passed directly to the patient's electronic medical record without the medical provider having to log onto the web-based medical software and then search for the patient's electronic medical record.

6. The method of claim 5 wherein the querying of step (b) in claim 5 comprises:
a. automatically sending a medical record number and a name of the patient, listed in the screen data, over a secure Internet connection to a server for the medical software;
b. automatically cross-referencing the medical record number and the name with the database of the web-based medical software; and
c. automatically determining whether or not the medical record number is associated with an active subscriber of the medical software.

7. The method of claim 5 wherein:
a. upon verifying that the medical record number is not associated with an active subscriber of the medical software:
i. automatically sending a negative result to the medical provider's computer; and
ii. thereafter allowing the medical software to go dormant.

8. A method comprising:
a. automatically capturing screen data about a medical patient from a third-party software running on a medical provider's computer;
i. wherein the medical provider is part of a medical group;
b. automatically querying a web-based database of medical software with the screen data to verify, provided the medical software is already logged on within a server of the medical group, whether or not a specific patient has an electronic medical record stored in the database; and
c. upon verifying the patient has an electronic medical record stored in the database, automatically providing a screen notification on the medical provider's computer and allowing the medical provider to be passed directly to the patient's electronic medical record without the medical provider having to log onto the web-based medical software and then search for the patient's electronic medical record in the database.

9. The method of claim 8 wherein the querying of step (b) in claim 8 comprises:
a. automatically sending a medical record number and a name of the patient, listed in the screen data, over a secure Internet connection to a server for the medical software;
b. automatically cross-referencing the medical record number and the name with the database of the web-based medical software; and
c. automatically determining whether or not the medical record number is associated with an active subscriber of the medical software.

10. The method of claim 8 wherein:
a. upon verifying that the medical record number is not associated with an active subscriber of the medical software:
i. automatically sending a negative result to the medical provider's computer; and
ii. thereafter allowing the medical software to go dormant.
